(19) United States
(12) Patent Application Publication
(10) Pub. No.: US 2024/0139697 A1
(43) Pub. Date: May 2, 2024

(54) SAMPLE RECEIVING ELEMENT FOR A LABORATORY DEVICE

(71) Applicant: Hans Heidolph GmbH, Kelheim (DE)

(72) Inventors: Andrej Jarresch, Schwabach (DE); Stefan Reinhold, Nurnberg (DE)

(73) Assignee: Hans Heidolph GmbH, Kelheim (DE)

(21) Appl. No.: 18/273,385

(22) PCT Filed: Dec. 22, 2021
(86) PCT No.: PCT/EP2021/087224

§ 371 Date: Jul. 20, 2023

(30) Foreign Application Priority Data
Jan. 22, 2021 (DE) 20 2021 100 315.4

(51) Int. Cl. B01F 33/452; B01F 35/92

(52) U.S. Cl. CPC B01F 33/452; B01F 35/92

(57) ABSTRACT

A sample receiving element for use in or with a laboratory device (1), wherein the sample receiving element (3) is configured to receive a sample to be treated by the laboratory device (1) and is penetrated by a magnetic field (20) during operation of the laboratory device, and wherein the sample receiving element (3) is configured to effect, at least in sections, an interruption of an electric current (21) induced by changes in the magnetic field that penetrates the sample receiving element (3).

The present invention relates to a sample receiving element for a laboratory device and to a laboratory device comprising such a sample receiving element.

An example of such a laboratory device is a magnetic stirrer. The magnetic stirrer comprises a sample receiving element in the form of a heating plate, on the upper side of which a sample receiving container is provided. A magnetic drive is arranged below the heating plate, which during operation generates a changing magnetic field, which in turn sets a magnetic stirring bar provided in the sample receiving container in a stirring motion. The heating plate can be made of aluminum or an aluminum alloy, for example, in order to permit good heat transfer to the sample receiving container.

DE 10 2006 005 155 B3 describes a magnetic stirrer having a housing and a heating plate which is heated by a heating device on its underside, a magnetic drive being provided below the heating plate in the housing, which magnetic drive generates a changing magnetic field which is suitable for imparting a stirring motion to a stirrer in a container standing on the heating plate. The heating plate comprises a metal-ceramic layer composite with a base layer of an aluminum alloy and a ceramic layer facing the container.

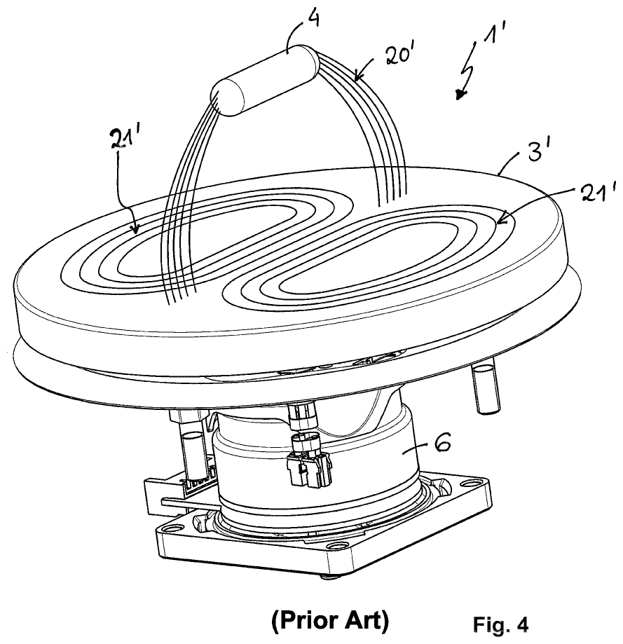

FIG. 4 shows a magnetic stirrer 1′ according to the prior art with a heating plate or placement plate 3′, which has a round shape and is formed as a continuous layer of a base material at least in a plane parallel to the surface of the placement plate 3′. Further, the magnetic stirrer 1′ has a magnetic drive 6 and a drive magnet (not shown) for generating, in operation, a changing magnetic field which sets in motion a magnetic stirring bar 4 arranged in a sample. As shown schematically in FIG. 4, during operation of the magnetic stirrer the changing magnetic field (represented by the magnetic field lines 20′) penetrates the placement plate 3′ and, in particular in interaction with the magnetic field of the magnetic stirring bar 4, can induce electric eddy currents 21′ in the placement plate 3′, in particular if the latter is made of a material with good electrical conductivity, such as aluminum or an aluminum alloy. According to Lenz's rule, these eddy currents 21′ in turn generate a magnetic field which counteracts the magnetic field generating them and thus weaken the changing magnetic field of the drive magnet and/or cause the drive to decelerate.

It is therefore an object of the present invention to provide an alternative or improved sample receiving element and an alternative or improved laboratory device with which the drive energy can be used as efficiently as possible. This object is solved by a sample receiving element according to claim 1 and a laboratory device according to claim 15. Further developments are given in the respective dependent claims.

A sample receiving element according to the invention serves for use in or with a laboratory device and is configured to receive a sample to be treated by the laboratory device and being penetrated by a magnetic field during operation of the laboratory device. The sample receiving element is configured to effect, at least in sections, an interruption of an electric current induced by changes in the magnetic field that penetrates the sample receiving element.

This makes it possible, for example, to prevent or at least reduce induced electric currents, in particular eddy currents, in the sample receiving element and thus to use the drive energy of a magnetic drive of the laboratory device as efficiently as possible and to reduce energy losses, as well as to enable the use of drive magnets made of a metal from the rare earth group.

The sample receiving element can be a component of the laboratory device, such as being formed as a placement plate of a magnetic stirrer, or can be a sample receiving element provided separately from the laboratory device, such as a container or pot for receiving a sample.

Preferably, the sample receiving element can be temperature-controlled by a temperature control device in order to allow heat transfer from or to a sample received by the sample receiving element. A temperature control device is understood to mean, in particular, a device which is configured to heat and/or cool the sample receiving element and/or a sample arranged thereon. The temperature control device can be a temperature control device integrally formed with the sample receiving element, or a temperature control device provided separately or externally from the latter, which is connected to the sample receiving element in a thermally conductive manner. For example, the temperature control device can enable heating and/or cooling the sample to be treated.

Preferably, the sample receiving element has a first side facing the sample and a second side facing away from the sample, in particular opposite the first side, and the sample receiving element comprises a base layer of at least one base material and a separation layer, wherein the separation layer extends in a region of the sample receiving element from the first side to the second side of the sample receiving element and forms a zoning of the base layer, and the separation layer is formed of a separation layer material which has a greater specific electrical resistance than the at least one base material of the base layer. The separation layer can extend continuously from the first side to the second side of the sample receiving element, or it can be formed only in sections between the first side and the second side. In the case where the base layer is formed from two or more base materials, it is further preferred that the separation layer material has a greater specific electrical resistance than all of the base materials of the base layer.

The first side of the sample receiving element facing the sample can, for example, be an upper side on which the sample, in particular a sample receiving container, is arranged, e.g. if the sample receiving element is designed as a placement plate. Alternatively, the first side of the sample receiving element can be, for example, an inner side of a container in which the sample is provided. Accordingly, the second side facing away from the sample can be, for example, a lower side opposite the upper side, or alternatively an outer side of a container.

As a result of the separation layer being formed from a separation layer material that has a greater specific electrical resistance (i.e. is less electrically conductive or has lower electrical conductivity) than a base material of the base layer, the separation layer has an electrically insulating effect at least up to a certain current intensity. Thus, for example, induced electric currents substantially cannot flow through the separation layer, which can lead to an overall reduction in electric currents occurring in the sample receiving element.

Preferably, the separation layer is at least partially formed by conversion from the base material of the base layer, in particular by generating an oxidic layer by anodic oxidation of the base layer and/or by passivation of the base layer. The generation of an oxidic layer by anodic oxidation of the base layer can be carried out, for example, in a process which is also known under the term “anodizing process” or “anodization” (from Eloxal, abbreviation for electrolytic oxidation of aluminum). In this process, for example in contrast to plating processes, the layer is formed by transforming the surface of the base layer in an electroplating bath, with the base layer forming the anode. Alternatively, the separation layer can be formed, for example, by electrophoretic deposition, in particular cathodic dip coating (CDP). The formation of the separation layer by conversion from the base material of the base layer has, for example, the advantage that the separation layer can be produced in a simple manner from the base material as an electrically essentially non-conductive layer. Thus, for example, a layer which can interrupt an electric current flow in the sample receiving element can be provided in a simple manner. In addition, the separation layer formed in this way can, for example, have a particularly smooth surface.

Alternatively or additionally, the separation layer can be a layer formed separately from the base layer, in particular a plastic layer. This provides, for example, for different types of separation layer, which can also be combined with each other.

Preferably, the base material is an electrical conductor and the separation layer material is an electrical non-conductor. A subdivision into electrical non-conductors (insulator) and electrical conductors can be made, for example, on the basis of the specific electrical resistance ρ of the respective material, wherein, for example, materials with ρ<100 Ω·mm²/m are designated as conductors and materials with ρ>10¹² Ω·mm²/m are designated as insulators. This provides, for example, a separation layer that can interrupt an electric current flow in the sample receiving element.

Preferably, in a direction parallel to the first side and/or the second side of the sample receiving element, the separation layer has an extension of 50 μm to 130 μm, more preferably of 60 μm to 120 μm, and even more preferably of 90 μm to 110 μm. This provides, for example, a relatively thin separation layer that does not substantially impede transfer of thermal energy through the sample receiving element to or from the sample.

Preferably, the base material is an aluminum alloy, more preferably an aluminum-magnesium-silicon alloy, such as material No. 3.2315, according to European Standard EN AW 6082; AlSi1MgMn or a similar material. Since an aluminum alloy has good thermal conductivity, using it as a base material can enable good thermal energy transfer from or to the sample receiving element, as well as good control of the temperature of the sample receiving element by a temperature control device.

Preferably, the sample receiving element is a plate having a defined geometric shape, preferably a circular, oval, rectangular, or square plate, and the separation layer is provided in a centered region of the plate such that the separation layer divides the base layer into a first zone and a second zone provided around the first zone. Further preferably, a largest diameter of the first zone substantially corresponds to a maximum extension of a magnetic stirring bar that can be set in motion by the magnetic field that penetrates the sample receiving element. Thus, the separation layer is provided, for example, in a region in which the magnetic field penetrates the sample receiving element during operation of the laboratory device, whereby the greatest possible reduction of occurring electric currents can be effected. In a further preferred embodiment, the sample receiving element is a circular plate and the separation layer is provided in a centered annular region of the plate such that the separation layer divides the base layer into a first circular zone and a second annular zone provided therearound. Further preferably, the diameter of the first zone substantially corresponds to a maximum extension of a magnetic stirring bar.

Preferably, the sample receiving element has a first side facing the sample and a second side facing away from the sample, in particular opposite the first side, and a recess extending from the first side to the second side is provided in a region of the sample receiving element. The recess can be provided alternatively or additionally to the separation layer described above. The recess is formed continuously from the first side to the second side of the sample receiving element. By providing such a recess, similar to the separation layer described above, an interruption of electric currents induced in the sample receiving element during operation of the laboratory device can be achieved.

Preferably, a protective layer is provided on the first side of the sample receiving element, wherein further preferably the protective layer consists of the same material as the separation layer and/or wherein further preferably the protective layer is at least partially formed by conversion from the base material of the base layer. Thus, for example, a layer is provided on the first side of the sample receiving element which protects the sample receiving element, in particular against mechanical influences such as scratching, and/or chemical influences such as corrosion.

A laboratory device according to the invention comprises a sample receiving element described above, wherein preferably the laboratory device is configured as a magnetic stirrer and further preferably the sample receiving element is configured as a placement plate, in particular a temperature control plate, of the magnetic stirrer. Thus, for example, the effects described above with respect to the sample receiving element can also be achieved with a laboratory device.

A method according to the invention serves to manufacture a sample receiving element for a laboratory device, wherein the sample receiving element is configured to receive a sample to be treated by the laboratory device and is penetrated by a magnetic field during operation of the laboratory device, and the sample receiving element has a first side facing the sample and a second side facing away from the sample, in particular opposite the first side. The method comprises the steps of: providing a base layer of the sample receiving element, and forming a separation layer in a region of the sample receiving element such that the separation layer extends from the first side to the second side of the sample receiving element and forms a zoning of the base layer, wherein the separation layer is formed of a separation layer material having a greater specific electrical resistance than a base material of the base layer. The step of forming a separation layer can include a step of forming a recess, wherein the recess is provided in a region of the sample receiving element and extends from the first side to the second side. Preferably, a matching insert is inserted into the recess, which insert is manufactured separately. The insert forms the first zone of the base layer and can be made of the same material as the first zone of the base layer. However, the insert can also be made of a different material, preferably of an aluminum alloy, too. In an alternative method, at least a first zone of the base layer is removed when forming a recess so that the first zone and a second zone of the base layer formed by removing the first zone are present.

In the case of the separately manufactured insert, and alternatively in the case of the insert removed during the formation of the recess, which may still be brought to the correct dimensions, the first zone has a first, outer edge and the second zone has a second, inner edge. Subsequently, the separation layer is formed on the first edge and/or the second edge, and the sample receiving element is formed by subsequently joining the first and second zones, in particular inserting the first zone into the second zone of the base layer, so that the separation layer is formed between the first and second zones. Further preferably, the joining is performed by thermal interference fit.

The method according to the invention can also be further developed by the features of the sample receiving element and/or the laboratory device described above. Likewise, the sample receiving element according to the invention and the laboratory device can be further developed by the features of the method according to the invention described above, and the features of the sample receiving element and of the laboratory device can be used among one another for further development.

Further features and expediencies of the invention will be apparent from the description of exemplary embodiments with reference to the accompanying drawings.

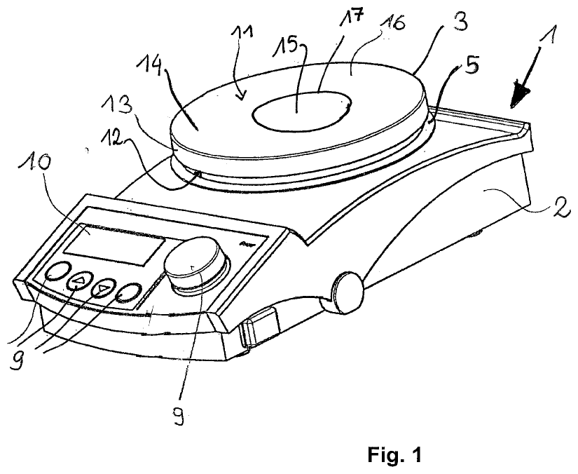

FIG. 1 shows a schematic perspective view of an embodiment of a laboratory device according to the present invention in the form of a magnetic stirrer;

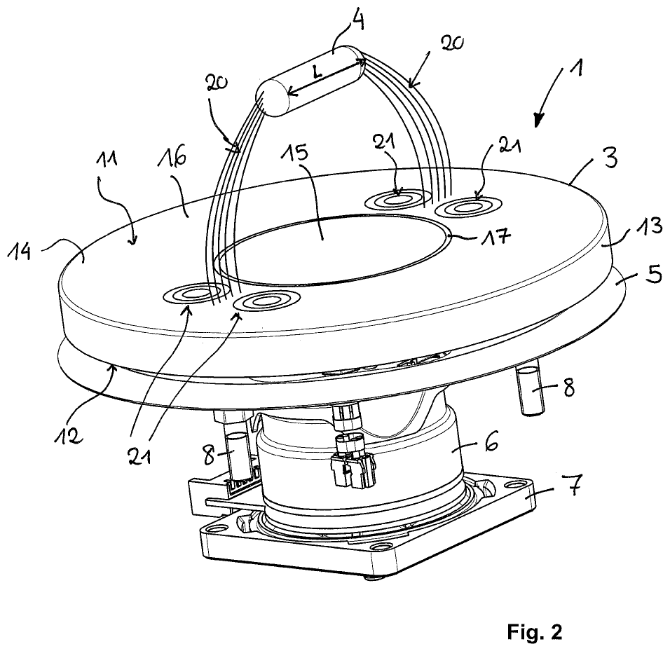

FIG. 2 shows a schematic, perspective view of the magnetic stirrer shown in FIG. 1, wherein the magnetic stirrer is shown without a housing and with purely schematically shown magnetic field lines during operation of the magnetic stirrer;

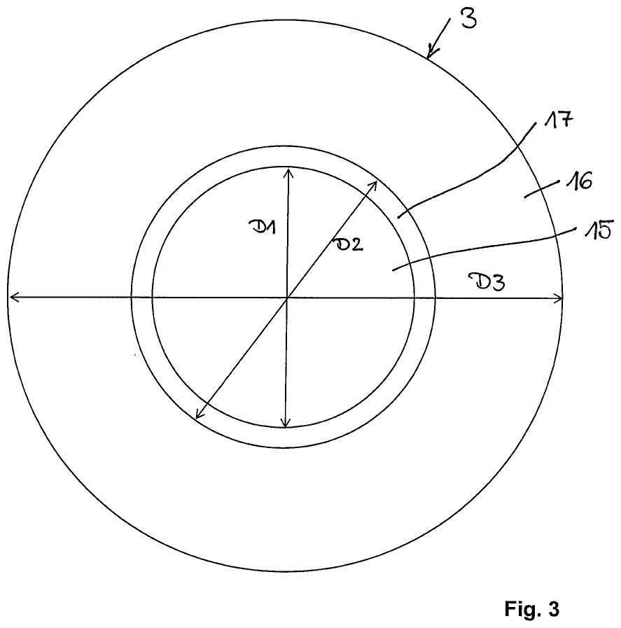

FIG. 3 shows a schematic view of a placement plate from above of the magnetic stirrer shown in FIGS. 1 and 2;

FIG. 4 shows a schematic, perspective view of a magnetic stirrer according to the prior art, wherein the magnetic stirrer is shown without a housing and with purely schematically shown magnetic field lines during operation of the magnetic stirrer;

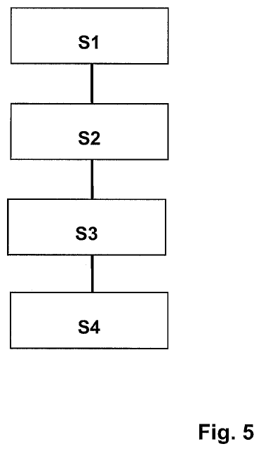

FIG. 5 is a schematic representation of steps for manufacturing the magnetic stirrer shown in FIGS. 1 to 3.

In the following, a first exemplary embodiment of a laboratory device according to the present invention is described with reference to FIGS. 1 to 3. The laboratory device shown in FIGS. 1 to 3 is designed as a magnetic stirrer 1. The magnetic stirrer 1 comprises a housing 2 (not shown in FIG. 2), on the upper side of which a sample receiving element designed as a placement plate 3 is provided, and a magnetic stirring bar 4 (see FIG. 2), which can be placed in a sample to be treated with the magnetic stirrer 1 (not shown in the figures) above the placement plate 3. A heat reflector 5 is optionally arranged between the placement plate 3 and the housing 2.

A magnetic drive 6 (see FIG. 2) and a drive magnet (not shown in the figures) are provided in the housing 2, which are configured such that the magnetic drive 6 sets the drive magnet in motion, in particular a rotational motion, during operation. Thus, a changing, preferably rotating, magnetic field is generated. In FIG. 2, the magnetic drive 6 is mounted on a base plate 7, which is attached to the housing 2 (not shown in FIG. 2). Furthermore, attachment elements 8 are provided by means of which the placement plate 3 and, if applicable, the optional heat reflector 5 are attached to the housing 2 (not shown in FIG. 2). The changing magnetic field can also be generated in other ways, for example by electronic control of coils.

Optionally, the placement plate 3 is designed as a temperature control plate, in particular as a heating plate. For this purpose, the placement plate has a temperature control device, in particular a heating device, (not shown in the figures) for supplying and/or removing thermal energy to or from the placement plate 3. The temperature control device (not shown in the figures) can be integrally formed with the placement plate, for example in the form of temperature control elements integrated in the placement plate. Alternatively, the temperature control device can be provided separately from the placement plate and connected thereto in a thermally conductive manner.

Control elements 9 are provided on the housing 2 for controlling the operation of the magnetic stirrer 1, for example a heating temperature of the placement plate and/or characteristics of the changing magnetic field that can be preset by the magnetic drive 6. An optional display unit 10, for example a display, serves to display set (target) values and/or to display (actual) values according to which the operation of the magnetic stirrer is controlled. Alternatively, a control unit provided separately from or integrally with the magnetic stirrer can be provided for controlling the individual components of the magnetic stirrer (not shown in the figures).

The placement plate 3 has a first side facing away from the housing 2 (i.e. facing a sample) and designed as an upper side 11, and a second side facing the housing 2 (i.e. facing away from a sample) and designed as a lower side 12. The upper side 11 and the lower side 12 are opposite sides of the placement plate 3. A circumferential edge 13 of the placement plate 3 extends between the upper side 11 and the lower side 12. A sample to be treated is provided on the upper side 11 of the placement plate 3, which is not shown in the figures, for example in a sample receiving container (not shown) arranged on the upper side 11. In the present embodiment, the placement plate 3 is circular, i.e. the upper side 11 and the lower side 12 are each circular.

A protective layer 14 is optionally provided on the upper side 11 of the placement plate 3.

In the embodiment shown in FIGS. 1 to 3, the placement plate 3 is substantially divided into a first zone 15, a second zone 16, and a separation layer 17. The separation layer 17 is formed in a region of the placement plate 3 between the first zone 15 and the second zone 16, thus separating the first zone 15 and the second zone 16 from each other. The separation layer 17 extends continuously from the upper side 11 to the lower side 12 of the placement plate 3. The first zone 15 and the second zone 16 are formed of a base material, and the separation layer 17 is formed of a separation layer material different from the base material.

As shown in the top view in FIG. 3, in the present embodiment the first zone 15 of the base layer is a central circular zone of the placement plate 3 with a first diameter D1. The separation layer 17 directly adjoins the first zone 15 radially and is formed in an annular shape around the first zone 15. The separation layer 17 thus extends in a region between the first diameter D1 and a second diameter D2 of the placement plate 3. The second zone 16 of the base layer directly adjoins the separation layer 17 radially and is formed in an annular shape around the separation layer 17. The second zone 16 thus extends in a region between the second diameter D2 and a third diameter D3 of the placement plate 3.

Preferably, the first diameter D1 of the placement plate 3, in which the first zone 15 of the base layer is provided, and/or the second diameter D2, at which the second zone 16 of the base layer adjoins the separation layer 17, substantially corresponds to a maximum extension of the magnetic stirring bar 4, for example to a length L of an elongate magnetic stirring bar (see FIG. 2). Preferably, the first diameter D1 and the second diameter D2 are only slightly different so that the separation layer 17 is a thin layer compared to the first and second zones 15, 16. For example, the thickness of the separation layer is between about 90 μm and about 110 μm. In the present embodiment, the third diameter D3 corresponds to an overall diameter of the placement plate 3. The first, second and third diameters D1, D2 and D3, respectively, are not shown to scale in FIG. 3; rather, for a better representation of the separation layer, the difference between the second diameter D2 and the first diameter D1 is shown to be too large in relation to the individual diameters in FIG. 3.

The base material of the base layer of the first and second zones 15, 16 and the separation layer material of the separation layer 17 differ in that the separation layer material has a greater electrical resistivity than the base material. Preferably, the separation layer material is an electrical non-conductor (insulator) and the base material is an electrical conductor. For example, the base material can be an aluminum alloy, in particular an aluminum alloy containing silicon, magnesium and manganese (aluminum-magnesium-silicon alloy), such as the alloy designated AlSi1MgMn according to European Standard EN-AW 6082 (material number 3.2315). The separation layer material can in particular contain aluminum oxide (Al₂O₃). Preferably, the separation layer material of the separation layer 17 is formed by conversion from the base material of the base layer, in particular by generating an oxidic layer by anodic oxidation of the base layer. An exemplary manufacturing process for the placement plate 3 is described below with reference to FIG. 5.

In operation of the magnetic stirrer 1, the sample or a container containing it (not shown in the figures) is placed on the placement plate 3 and the magnetic stirring bar 4 is inserted into the sample or container. By switching on the magnetic drive 6, the drive magnet (not shown in the figures) is set into a rotational movement, which in turn causes the magnetic stirring bar 4 to stir in the sample or container and thus causes the sample to be mixed.

As shown schematically in FIG. 2, during operation of the magnetic stirrer 1 the placement plate 3 is penetrated by a magnetic field which is generated by the interaction of the drive magnet (not shown) and the magnetic stirring bar 4 and is depicted schematically by magnetic field lines 20 in FIG. 2. This changing magnetic field induces electric eddy currents 21 shown purely schematically in FIG. 2. Due to the separation layer 17, which is electrically insulating, the eddy currents 21 can only propagate in a confined region (in FIG. 2 the second zone 16 of the base layer). Due to the fact that the first and/or second diameter D1 or D2 of the placement plate 3 substantially corresponds to the maximum extension of the magnetic stirring bar 4 (see above), the separation layer 17 is substantially provided in the region of the placement plate 3 in which the magnetic field lines 20 penetrate the placement plate. This can provide the greatest possible attenuation or prevention of the eddy currents 21 that occur.

In the following, a method for manufacturing the placement plate 3 of the magnetic stirrer 1 according to the invention is described with reference to FIG. 5. In a first step S1 of the method, a base layer of the placement plate is provided. In the embodiment described with reference to FIGS. 1 to 3, the base layer is provided as a cylindrical layer (i.e., having a circular upper side 11 and lower side 12 each) of the base material, for example, the aluminum-magnesium-silicon alloy described above, having a diameter D3 (see FIG. 3).

Subsequently, in a second step S2 of the method, a part corresponding to the first zone 15 (see FIGS. 1-3) of the base layer is removed, e.g. cut out.

An insert forming the first zone 15 is manufactured separately, the first zone 15 having a first edge (not shown in the figures) and the second zone 16 having a second edge (not shown in the figures). Subsequently, in a third step S3 of the method, the separation layer or the separation layer material is formed at the first edge and/or the second edge of the first and second zones, respectively. Preferably, in doing so, the separation layer is formed by conversion from the base material of the base layer by generating an oxidic layer at the first and/or second edge by anodic oxidation of the base layer. Alternatively, the separation layer can be formed by passivation of the base layer at the first and/or second edge.

Subsequently, in a fourth step S4 of the method, the first zone 15 is inserted into the second zone 16 of the base layer so that the separation layer 17 (see FIGS. 1-3) is formed between the first and second zones. The joining of the two zones of the base layer can be done, for example, by a thermal interference fit. The separation layer 17 is thus formed in a region of the base layer, wherein it extends continuously from the upper side 11 to the lower side 12 and forms a zoning of the base layer.

The formation of the separation layer in step S3 can be done in such a way that this layer is also formed on the upper side 11 of the sample receiving element, thus forming the protective layer 14.

The invention is not limited to the exemplary embodiment described above. For example, the separation layer can be a layer formed separately from the base layer, in particular a plastic layer, which is applied or inserted as a ring in the region between the two zones of the base layer, for example.

Also, the zoning of the placement plate by the separation layer is not limited to the embodiment described above. For example, more than two zones of the base layer can also be formed by the separation layer. The zoning of the base layer can also be formed other than by concentric circles (see FIGS. 1-3), for example by a spiral-shaped separation layer, so that a continuous region of the base layer is formed, which is, however, radially interrupted by the separation layer. Also, the separation layer can divide the base layer of the placement plate into at least two circular sectors (circular sections), wherein a circular sector is understood to be a partial area of a circular area which is bounded by a circular arc and two circular radii. Also, the separation layer can divide the base layer of the placement plate into at least two circular segments, wherein a circular segment is understood to be a partial area of a circular area which is bounded by a circular arc and a circular chord. Other zonings or a combination of these zonings are also possible within the scope of the present invention. The placement plate itself can also deviate from the circular design described above.

In the embodiment described above with reference to FIGS. 1-3 and 5, the first zone 15 and the second zone 16 of the base layer are formed of the same base material. However, it is also possible that the first zone and the second zone, or generally at least two zones of the base layer, are formed of different base materials. Plastic, nonmagnetic or non-conductive stainless steel, glass, ceramics, etc. can also be used as base materials. Likewise, the base layer, and possibly also the separation layer, can comprise further layers horizontally, i.e. parallel to the upper side 11 and/or lower side 12 of the placement plate. Also, the separation layer 17 need not extend continuously from the upper side 11 to the lower side 12 of the placement plate, e.g. it can also be interrupted, i.e. only partially formed between the upper side and the lower side.

According to a second exemplary embodiment of a laboratory device according to the present invention in the form of a magnetic stirrer, which is not shown in more detail in the figures, the placement plate comprises at least one recess instead of or in addition to the zoning of the base layer formed by the separation layer described above. The at least one recess is provided in at least one region of the placement plate. It extends at least partially from the upper side 11 to the lower side 12 of the placement plate. For example, the recess can be formed as a hole penetrating the placement plate from the upper side to the lower side. For example, the recess or hole can be provided in the region of the central circular region having the first diameter described above with respect to FIGS. 1-3 (i.e., instead of the first zone 15 in FIGS. 1-3). Alternatively, the at least one recess, preferably a plurality of holes, can be provided in an annular region of the placement plate, for example in an annular region containing the separation layer 17 in FIGS. 1-3.

Such a recess, in particular a hole, of the placement plate can also be used to effect an interruption, i.e. to weaken or prevent, of eddy currents 21 occurring during operation of the magnetic stirrer.

The present invention is not limited to a laboratory device in the form of a magnetic stirrer. Rather, the invention can also be applied to other laboratory devices which generate a changing magnetic field during operation. Furthermore, the invention is not limited to a placement plate as a sample receiving element. For example, the sample receiving element can comprise a so-called heat-on attachment. A heat-on attachment is an attachment for a heating plate and provides the thermal coupling between the heating plate and the sample container. The present invention is also applicable to a sample receiving element formed as a pot or other container. For example, the pot or container can be configured to receive a sample to be treated with the laboratory device. The zoning or formation of a separation layer according to the invention can be formed, for example, in a bottom of the heat-on attachment or the pot or container.

1. A sample receiving element for use in or with a laboratory device, the sample receiving element being configured to receive a sample to be treated by the laboratory device and being penetrated by a magnetic field during operation of the laboratory device, and
wherein the sample receiving element is configured to effect, at least in sections, an interruption of an electric current induced by changes in the magnetic field that penetrates the sample receiving element.

2. The sample receiving element according to claim 1, wherein the sample receiving element is temperature-controllable by a temperature control device to allow heat transfer from or to a sample received by the sample receiving element.

3. The sample receiving element according to claim 1, wherein the sample receiving element has a first side facing the sample and a second side facing away from the sample, in particular opposite the first side, and
wherein the sample receiving element comprises a base layer of at least one base material and a separation layer, the separation layer extending in a region of the sample receiving element from the first side to the second side of the sample receiving element and forming a zoning of the base layer, and
the separation layer is formed of a separation layer material having a greater specific electrical resistance than the at least one base material of the base layer.

4. The sample receiving element according to claim 3, wherein the separation layer is at least partially formed by conversion from the base material of the base layer, in particular by generating an oxidic layer by anodic oxidation of the base layer and/or by passivation of the base layer.

5. The sample receiving element according to claim 3, wherein the separation layer is a layer formed separately from the base layer, in particular a plastic layer.

6. The sample receiving element according to claim 3, wherein the base material is an electrical conductor and the separation layer material is an electrical non-conductor.

7. The sample receiving element according to claim 3, wherein in a direction parallel to the first side and/or to the second side of the sample receiving element, the separation layer has an extension of 50 μm to 130 μm, preferably of 60 μm to 120 μm, and more preferably from 90 μm to 110 μm.

8. The sample receiving element according to claim 3, wherein the base material comprises an aluminum alloy, preferably an aluminum-magnesium-silicon alloy.

9. The sample receiving element according to claim 3, wherein the sample receiving element is a plate having an outline of a defined geometric shape, preferably a circular plate, and the separation layer is provided in a centered region of the plate and has an outline corresponding to a defined geometric shape, wherein the separation layer divides the base layer into a first zone and a second zone provided therearound, preferably the first zone being circular and the second zone being annular.

10. The sample receiving element according to claim 9, wherein a diameter of the first zone substantially corresponds to a maximum extension of a magnetic stirring bar which can be set in motion by the magnetic field that penetrates the sample receiving element.

11. The sample receiving element according to claim 1, wherein the sample receiving element has a first side facing the sample and a second side facing away from the sample, in particular opposite the first side, and wherein a recess extending at least partially from the first side to the second side is provided in a region of the sample receiving element.

12. The sample receiving element according to claim 1, wherein a protective layer is provided on the first side of the sample receiving element.

13. The sample receiving element according to claim 12, wherein the protective layer consists of the same material as the separation layer and/or wherein the protective layer is formed at least partially by conversion from the base material of the base layer.

14. A laboratory device comprising a sample receiving element according to claim 1, wherein preferably the laboratory device is configured as a magnetic stirrer and further preferably the sample receiving element is configured as a placement plate, in particular a temperature control plate, of the magnetic stirrer.

15. A method for manufacturing a sample receiving element for a laboratory device, the sample receiving element being configured to receive a sample to be treated by the laboratory device and being penetrated by a magnetic field during operation of the laboratory device, and
wherein the sample receiving element is configured to effect, at least in sections, an interruption of an electric current induced by changes in the magnetic field that penetrates the sample receiving element,
preferably wherein the sample receiving element has a first side facing the sample and a second side facing away from the sample, in particular opposite to the first side, and the method comprises the following steps: providing a base layer of the sample receiving element and forming a separation layer in a region of the sample receiving element such that the separation layer extends from the first side to the second side of the sample receiving element and forms a zoning of the base layer,
wherein the separation layer is formed of a separation layer material having a greater specific electrical resistance than a base material of the base layer,
wherein the step of forming a separation layer preferably comprises a step of forming a recess, the recess being provided in a region of the sample receiving element and extending from the first side to the second side,
further preferably wherein a suitable insert is inserted into the recess, which insert is manufactured separately, in particular wherein the insert forms the first zone of the base layer,
or further preferably wherein in forming a recess, at least a first zone of the base layer is removed such that the first zone and a second zone of the base layer formed by removing the first zone are present.
